(19) United States
(12) Patent Application Publication
(10) Pub. No.: US 2002/0108377 A1
(43) Pub. Date: Aug. 15, 2002

(54) Process for supplying air to at least one gas turbine unit and at least one air distillation unit, an installation for practicing the same

(76) Inventor: Alain Guillard, Paris (FR)

Correspondence Address: YOUNG & THOMPSON, 745 SOUTH 23RD STREET 2ND FLOOR, ARLINGTON, VA, 22202

(21) Appl. No.: 10/029,915

(22) Filed: Dec. 31, 2001

(30) Foreign Application Priority Data
Dec. 29, 2000 (FR) 00 17321

(51) Int. Cl. F02C 7/00

(52) U.S. Cl. 60/772; 60/726

(57) ABSTRACT

According to this process, here is supplied with air, with a variable flow rate, the air distillation unit both by a compression apparatus and by a branch of the output of a compressor that supplies air to the gas turbine unit, and the supply flow rate of the distillation unit is varied by varying the flow rate through this branch.

The present invention relates to a process for supplying with air at least one gas turbine unit and at least one air distillation unit provided at its head with an apparatus for purifying air by adsorption, of the type in which air is supplied, at a variable flow rate, to the air distribution apparatus both by a compression apparatus and by a branch of the output of an air supply compressor of the gas turbine unit. A process of this type is described in EPO 795 728.

It frequently happens at industrial sites that a gas turbine is twinned with an air distillation unit.

The gas turbine unit takes part for example in the supply of an electrical distribution network. This unit comprises conventionally a compressor upstream of its combustion chamber, supplying this latter with compressed air.

The air distillation unit supplies products from the distillation of air, typically of a fluid rich in nitrogen and a fluid rich in oxygen. The air purification apparatus disposed ahead of this type of unit comprises at least two adsorbers purifying the air from water and CO₂. These adsorbers are supplied either solely by a compression apparatus, or by such an apparatus and by a branch of the flow of air supplying the combustion chamber of the turbine unit.

These adsorbers operate according to a cycle in which there is principally alternately an adsorption phase for purifying incoming air and a regeneration phase adapted to clean the adsorbent for the next adsorption phase. The regeneration of the adsorbent is the more effective when practiced at low pressure relative to the pressure maintained during adsorption, which requires repressurizing the adsorber after the regeneration phase.

This repressurization is conventionally carried out by an increase in the air flow rate supplied by the compression apparatus. However, this supplemental air flow rate requires an overdimensioning and hence an increase of cost, of this apparatus, because it is required for example to supply a supplemental compressed air flow rate comprised generally between 1 and 10% of the nominal flow rate processed by the purification apparatus, during at least 10 minutes per cycle time of two hours.

As a result, apart from this duration of repressurization, the dedicated compression apparatus operates below its nominal capacities.

One of the objects of the invention is to avoid this drawback under satisfactory economic conditions.

To this end, the invention has for its object a process of the mentioned type, in which the supply flow rate of the distillation unit is varied by varying the flow rate of said branch.

According to other characteristics of the invention:

the air purification apparatus comprises at least two adsorbers principally selectively in adsorption phase and in regeneration phase, the regeneration phase being followed by a step of repressurization of the adsorber, and the flow rate of said branch being varied cyclically with time, the maximum of this flow rate being reached during the repressurization of an adsorber;

the flow rate of said branch is comprised by a base positive flow rate that is substantially constant and a supplemental cyclically variable flow rate which is added to the base flow rate during at least a portion of the repressurization of each adsorber;

the supplemental flow rate is substantially comprised between about 1 and 20% of the flow rate of the compression apparatus;

the supplemental flow rate is substantially comprised between about 1 and 10% of the flow rate of the compression apparatus;

the supplemental flow rate is substantially less than 4% of the nominal flow rate of the compressor supplying the gas turbine unit;

the supplemental flow rate is substantially less than 2% of the nominal flow rate of the compressor supplying the gas turbine unit;

the supplemental flow rate is substantially less than 1% of the nominal flow rate of the compressor supplying the gas turbine unit;

the flow rate of the compression apparatus is maintained substantially constant.

The invention also has for its object an installation for the supply of air to at least one gas turbine unit and to at least one air distillation unit provided at its head with an apparatus for the purification of air by adsorption for the use of a process as defined above, of the type comprising an air supply line to the air purification apparatus, a compression apparatus for supplying air to the air purification apparatus and connected to the supply line, a branch partially connecting the output of an air supply compressor of the gas turbine unit to the air supply of the purification apparatus, characterized in that the branch comprises means for regulating the flow rate of air that passes through it.

According to other characteristics of this installation:

the air purification apparatus comprises at least two adsorbers principally selectively in adsorption phase and in regeneration phase, the regeneration phase being followed by a step of repressurization of the adsorber, and the regulation means are adapted to control an increase in the flow rate of air supplied by the branch during all or a part of the repressurization phase of each adsorber;

the air distillation unit comprises moreover an outlet line for the evacuation of air purified by the adsorbers of the purification apparatus, and means for selectively connecting the adsorbers to the supply line, to the evacuation line, and between themselves, and the connection means are adapted to control the regulation means;

the branch comprises means for adjusting the pressure between that of the output of the compressor of the gas turbine unit and that maintained at the inlet of the air purification apparatus;

the branch is connected to an intermediate compression stage of the compression apparatus;

the supply line comprises, downstream of the point of connection with the branch, pressure variation means.

The invention will be better understood from a reading of the description which follows, given solely by way of example and with respect to the accompanying drawings, in which:

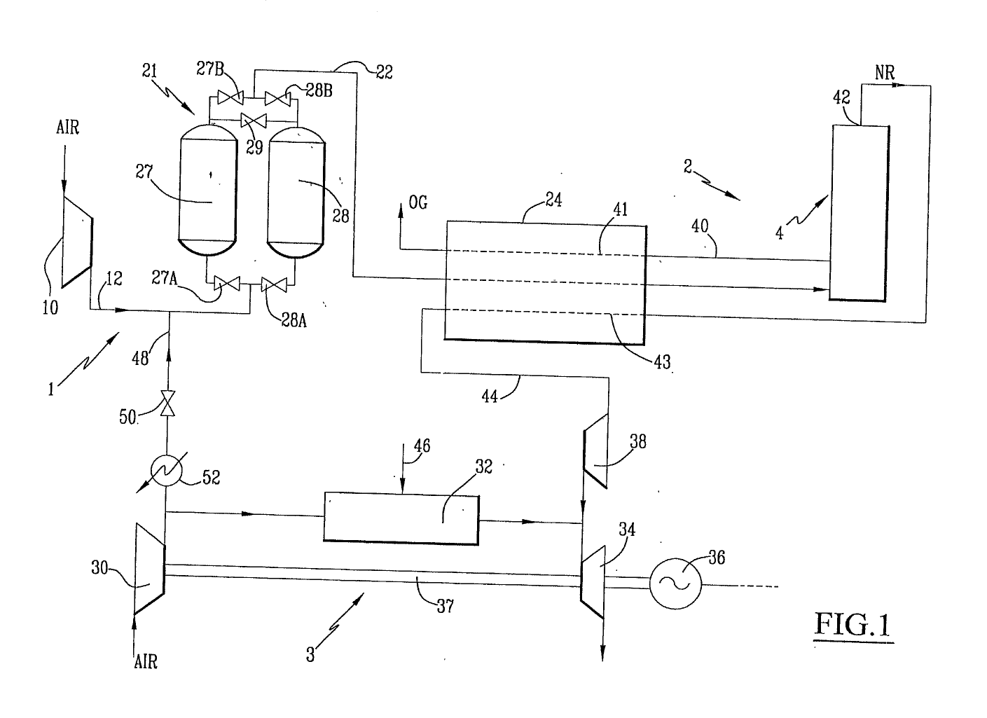

FIG. 1 is a schematic view of an installation according to the invention supplying an air distillation unit and a gas turbine unit;

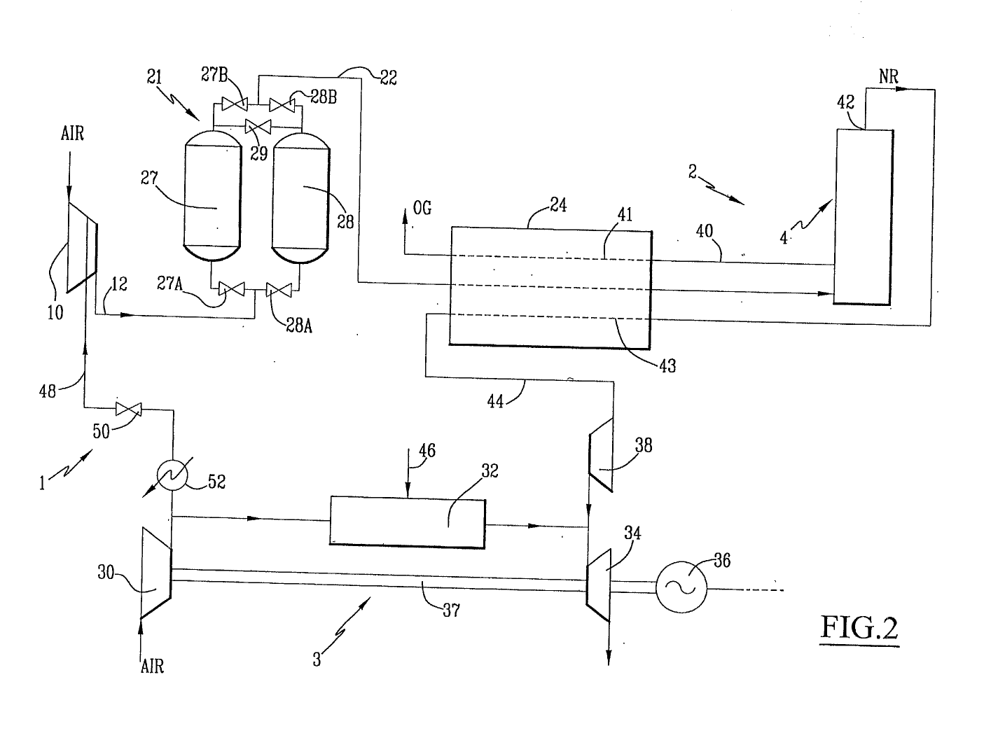

FIG. 2 is a view similar to FIG. 1, but of a second embodiment of such an installation.

In FIG. 1 is shown an installation 1 for the supply with air of an air distillation unit 2 and a gas turbine unit 3.

The installation 1 comprises an air compression apparatus 10 supplying air to the distillation unit 2.

This apparatus 10 comprises at least one compressor, as shown, but it could comprise several, arranged relative to each other in various arrangements for the production of compressed air according to the known art.

Moreover, this compression apparatus can supply with air other units (not shown), such as a network of air for controlling instruments for example.

The installation 1 moreover comprises an air supply line 12, supplying the distillation unit 2.

The air distillation unit 2 comprises essentially:

an apparatus 21 for the purification of air by adsorption,

an air evacuation line 22 at the outlet of the purification apparatus 21,

a principal heat exchange line 24,

an air distillation apparatus 4, for example in the form of a double distillation column; it could also be a triple column.

The air distillation unit 2 is capable of producing, at different pressures, various purities of mixtures rich in oxygen or in nitrogen. It can also produce a mixture rich in argon adapted to be separated later.

The purification apparatus comprises two adsorbers 27, 28, as well as connecting conduits and valves 27A, 27B, 28A, 28B and 29 which permit selectively connecting each adsorber either to the line 12 or to the line 22 or to each other.

The gas turbine unit 3 comprises essentially:

an air compressor 30, whose nominal output is greater, for example five times greater, than that of the compressor 10,

a combustion chamber 32,

a turbine 34 coupled to the compressor 30,

an alternator 36 driven by the shaft 37 common to the compressor 30 and to the turbine 34, and

a compressor 38.

Before describing in detail the operation of the installation 1 for air supply, the operations of the air distillation unit 2 and the gas turbine unit 3 will be quickly recited, it being understood that they are of the prior art.

The air to be distilled, first compressed and purified, is cooled by the principal heat exchange line 24 to adjacent its dew point, then is introduced into the apparatus 4. This latter produces, via a conduit 40, oxygen which is vaporized then reheated in the passages 41 of the exchange line while cooling the entering air.

The impure or residual nitrogen NR, withdrawn from the top of the double column by an outlet 42, is sent to a series of passages 43 in the exchange line 24. The residual nitrogen is reheated in these passages 43 causing the cooling of the air to be distilled. This residual nitrogen is then sent, after compression in 38, toward the gas turbine unit 3 by a conduit 44.

The general operation of the gas turbine unit 3 is as follows.

Compressed air is sent toward the combustion chamber 32, into which a combustible under pressure, such as natural gas, is introduced via a conduit 46.

The gases from the combustion in the chamber 32 are mixed with the residual nitrogen flow in the conduit 44, compressed in the compressor 38 substantially to the same pressure and sent toward the inlet of the turbine 34, where they expand while driving the turbine 34, and, by means of the shaft 37, the compressor 30 and the alternator 36. This alternator 36 supplies for example an electric distribution network.

To supply with air the air distillation 2 and the gas turbine unit 3, the installation 1 uses the following process.

On the one hand, the compressor 30 supplies the turbine unit 3 with compressed air.

On the other hand, the distillation unit 2 is supplied with compressed air both by the compressor 30 and by the compressor 10. Whilst all the compressed air from the compressor 10 is supplied to the air distillation unit 2, only a branch of the flow rate is used from the output of the compressor 30. This branch circulates in a conduit 48 provided with an adjustment valve 50 and is connected to the line 12. For example, in the mentioned numerical example, the compressor 10 and the branch 48 each deliver into the line 12 about 10% of the flow rate of the compressor 30. Thus, there circulates in the supply line 12 about 20% of this flow rate, supplying the distillation unit 2.

The conduit 48 is also provided with a refrigerant 52 supplied by a cooling circuit (not shown). This refrigerant lowers the temperature of the air passing through it if the downstream treatments so require.

The two adsorbers 27 and 28 of the upstream purification apparatus 21 each follow a cycle in which an adsorption phase at a high pressure of the cycle, that is greater than atmospheric pressure alternates with a low pressure regeneration phase, which is to say substantially at atmospheric pressure, or at a mean pressure. The adsorbers 27 and 28 operate offset, such that at any moment, there is always at least one adsorber undergoing adsorption supplying the outlet line 22 with purified compressed air. An adsorber which has reached the end of its regeneration phase is repressurized, such that at the moment at which it recommences its adsorption phase, it has a pressure substantially equal to that maintained in the line 22.

According to the process of the invention, this repressurization is ensured, at least partially, by a supplemental air flow supplied by the compressor 30 of the gas turbine unit 3. This supplemental flow rate is added to the base flow rate which the branch continuously maintains, as described above.

This supplemental flow rate is regulated by the valve 50 such that, during repressurization of an adsorber 27, 28, the valve 50 lets pass a flow rate of air which is greater than that permitted throughout the rest of this repressurization. For example, this supplemental flow rate is comprised between 2 and 10% of the nominal air flow rate treated by the purification apparatus, during about at least ten minutes for a cycle time of about 2 hours.

The process and the installation according to the invention thus permit dimensioning the compressor 10 for a flow rate maintained substantially constant during all the duration of operation of the installation.

Moreover, to the extent to which the supplemental flow rate derived from the output of the compressor 30 represents only a small fraction, of the order of several %, of the total flow rate from this compressor, and having regard to the output curves of the conventional gas turbines, the overall output of the gas turbine unit remains thus substantially constant.

Also, the overall energy removed from the site, which is to say the energy produced less the energy consumed averaged over a significant period of operation, is practically constant.

Preferably, the adjustment valve 50 is controlled by a regulation device (not shown), which takes account of the movements of the valves of the purification apparatus 21.

Thus, for example, considering that the cylinder 27 is in the adsorption phase and that the cylinder 28, terminating its regeneration phase, triggers is repressurization step, the supply valve 27A and evacuation valve 27B of air of the cylinder 27 are open, whilst, maintaining closed the outlet valve 28B of the cylinder 28, the valve 29 for balancing pressure between the two adsorbers 27 and 28 opens progressively such that the pressure within the cylinder 28 increases. This repressurization of the adsorber 28 can be completed, according to certain known operative arrangements, by opening the supply valve 28A of this cylinder, whilst holding closed the outlet valve 28B.

The opening of the balancing valve 29, as well as that of the supply valve 28A as the case may be, are taken into account by the mentioned regulation device and involve the increase of the air flow rate supplied by the line 48, by increase of the opening of the valve 50 and/or by increased powering of the compressor 30.

In FIG. 2 is shown a second embodiment of the installation 1 which differs from that shown in FIG. 1 only by the point of connection of the branch 48 relative to the air supply for the distillation unit 2.

According to this embodiment, the branch 48 is connected to an intermediate stage of the compression apparatus 10. The operation of this embodiment is analogous to that of the installation shown in FIG. 1.

It is thus possible to correct a pressure difference between that of the output of the compressor 30 and that maintained at the input of the air purification unit 21.

A modification (not shown), capable also itself of such a pressure correction, consists in providing the branch 48 with one or several compressors and/or superchargers.

Another modification, also not shown, consists in providing the branch 48 with an expansion valve or a turbine, capable this time of lowering the pressure at the output of the compressor 30 before its connection to the air supply of the purification apparatus 21.

It is also to be noted that a pressure correction can be envisaged in the supply line 12, downstream of the point of connection of the branch 48, by means of a supercharger or a turbine for example.

As a modification of the process, the air supply of the air distillation unit 2 is ensured exclusively by the compression apparatus 10, except during repressurization of an adsorber, during which the valve 50 permits the passage of the supplemental flow described above.

1. Process for supplying air to at least one gas turbine unit and at least one air distillation unit comprising an apparatus (21) for the purification of air by adsorption, comprising at least two adsorbers (27, 28) principally selectively in adsorption phase and in regeneration phase, the regeneration phase being followed by a step of repressurization of the adsorber, of the type in which air is supplied, with a variable flow rate, to the air distillation apparatus both by a compression apparatus (10) and by a branch (48) of the output of a compressor (30) that supplies air to the gas turbine unit (3), characterized in that the flow rate of the supply of the distillation unit is caused to vary by varying the flow rate of this branch cyclically with time.

2. Process according to claim 1, characterized in that the maximum of the branch flow is achieved during repressurization of an adsorber.

3. Process according to claim 2, characterized in that the flow of said branch is comprised by a positive base flow rate that is substantially constant and a supplemental flow rate that is cyclically variable and that is added to the base flow rate during at least a portion of the repressurization of each adsorber (27, 28).

4. Process according to claim 3, characterized in that the supplemental flow rate is substantially comprised between 1 and 20% of the flow rate of the compression apparatus (20).

5. Process according to one of claims 3 or 4, characterized in that the supplemental flow rate is substantially comprised between about 1 and 10% of the flow rate of the compression apparatus (10).

6. Process according to one of the preceding claims, characterized in that the supplemental flow rate is substantially less than 4% of the nominal flow rate of the compressor (30) supplying the gas turbine unit (3).

7. Process according to one of the preceding claims, characterized in that the supplemental flow rate is substantially less than 2% of the nominal flow rate of the compressor (30) supplying the gas turbine unit (3).

8. Process according to one of the preceding claims, characterized in that the supplemental flow rate is substantially less than 1% of the nominal flow rate of the compressor (30) supplying the gas turbine unit (3).

9. Process according to one of the preceding claims, characterized in that the flow rate of the compression apparatus (10) is maintained substantially constant.

10. Installation for supplying air to at least one gas turbine unit and at least one air distillation unit provided upstream with an apparatus (21) for the purification of air by adsorption for the practice of a process according to any one of the preceding claims, of the type comprising a line (12) for supplying air to the air purification apparatus, a compression apparatus (10) for supplying air to the air purification apparatus and connected to the supply line, a branch (48) partially connecting a portion of the output of a compressor (30) for supplying air to the gas turbine unit (3) to the supply of air purification apparatus, characterized in that the branch (48) comprising air flow regulation means (50) is characterized in that the regulation means are means permitting varying the flow rate cyclically with time.

11. Installation according to claim 10, characterized in that the air purification apparatus (21) comprises at least two adsorbers (27, 28) principally selectively in adsorption phase and regeneration phase, the regeneration phase being followed by a step of repressurization of the adsorber, and in that the regulation means (50) are adapted to produce an increase in the air flow supplied by the branch (48) during all or a portion of the repressurization phase of each adsorber.

12. Installation according to claim 11, characterized in that the air supply unit (1) comprises moreover an outlet line (22) for air purified by the adsorbers (27, 28) of the purification apparatus (21), and means (27A, 27B, 28A, 28B, 29) for selectively connecting the adsorbers to the supply line (12), to the evacuation line and to each other, and in that the connection means are adapted to control the regulation means (50).

13. Installation according to one of claims 10 to 12, characterized in that the branch (48) comprises means for adjusting the pressure between that of the output of the compressor (30) of the gas turbine unit (3) and that maintained at the inlet of the air purification apparatus (21).

14. Installation according to one of claims 10 to 13, characterized in that the branch (48) is connected to an intermediate compression stage of the compression apparatus (10).

15. Installation according to one of claims 10 to 14, characterized in that the supply line (12) comprises, downstream of the point of connection with the branch (48), pressure variation means.
